(19) United States
(12) Patent Application Publication
(10) Pub. No.: US 2020/0096290 A1
(43) Pub. Date: Mar. 26, 2020

(54) ELECTROMAGNETIC GUN OPEN SAFE

(71) Applicant: ALEXANDER CHEE HO HUI, San Mateo, CA (US)

(72) Inventor: ALEXANDER CHEE HO HUI, San Mateo, CA (US)

(21) Appl. No.: 16/581,643

(22) Filed: Sep. 24, 2019

Related U.S. Application Data
(60) Provisional application No. 62/736,164, filed on Sep. 25, 2018.

(51) Int. Cl. F41C 33/06; E05B 65/00; G07C 9/00

(52) U.S. Cl. CPC F41C 33/06; G07C 9/00563; E05B 65/0075

(57) ABSTRACT

An electromagnetic gun-locking safe, substantially harder to defeat than mere mechanical-system trigger locks, wherein the safe allows visibility of the gun at all times, wherein the safe utilizes over 1000 lbs. of electromagnetic force, and wherein said magnetic force, along with the shape of the safe's enclosure, along with an integrated trigger lock, together prevent the pistol from being removed, moved or slid, and wherein the trigger and other gun mechanisms can not be operated unless the gun owner activates a unique lock configuration system to deactivate said electromagnet to access the gun and its trigger mechanism.

### RELEVANT RELATED PRIOR ART

1. U.S. Pat. No. 5,713,149A Electronic Trigger Lock Jefferey Cady
2. WO2000065292A1 Biometrically activated lock enablement system John F. Klebes
3. US10132113B2 Alarm-triggered gun safe Ryan Stevenson
4. U.S. Pat. No. 5,416,826A Gun safe Gerald Butler
5. US20120291327A1 Biometric quick release gun lock Michael Boutot

### RELATED APPLICATIONS

This application claims priority to U.S. Provisional Utility Application No. 62/736,164 filed Sep. 25, 2018. The entirety of this provisional application is herein incorporated by reference.

### BACKGROUND

The instant invention solves the problem of gun security and storage. It is an open style safe. It allows visibility of the gun stored at all times. The claimed invention differs from what currently exists; There are currently no open style gun safes.

The instant electromagnetically-locked gun safe uses electromagnetism to lock its safe door when energized. The holding force is collinear with the load, and the lock and armature plate are positioned face-to-face to achieve optimal operation.

The electromagnet portion of the lock is attached to the door frame and a mating armature plate is attached to the door. The two components are in contact when the door is closed.

When the electromagnet is energized, a current passing through the electromagnet creates a magnetic flux that causes the armature plate to attract to the electromagnet, creating a locking action.

Because the mating area of the electromagnet and armature is relatively large, the force created by the magnetic flux is strong enough to keep the door locked even under stress. In this case, the electromagnet creates over 1,000 lb. (lbf)

In an alternative embodiment, the device passes a current through one or more wire solenoid(s), thereby producing a magnetic field that locks the gun safe.

### SUMMARY

An electromagnetic gun-locking safe which is substantially harder to defeat the mechanical system than trigger locks, wherein the safe allows visibility of the gun at all times, wherein the safe utilizes over 1000 lbs. of electromagnetic force, and wherein said force, along with the shape of the safe's enclosure along with an integrated trigger lock, prevent the pistol from being moved, slid or removed, and wherein the trigger and other gun mechanisms can not being operated unless the gun owner activates a lock configuration system to deactivate said electromagnet to access the gun and trigger mechanism.

### BRIEF DESCRIPTION OF THE DRAWINGS

FIG. 1: perspective elevational view of the instant invention in its open/unlocked position;

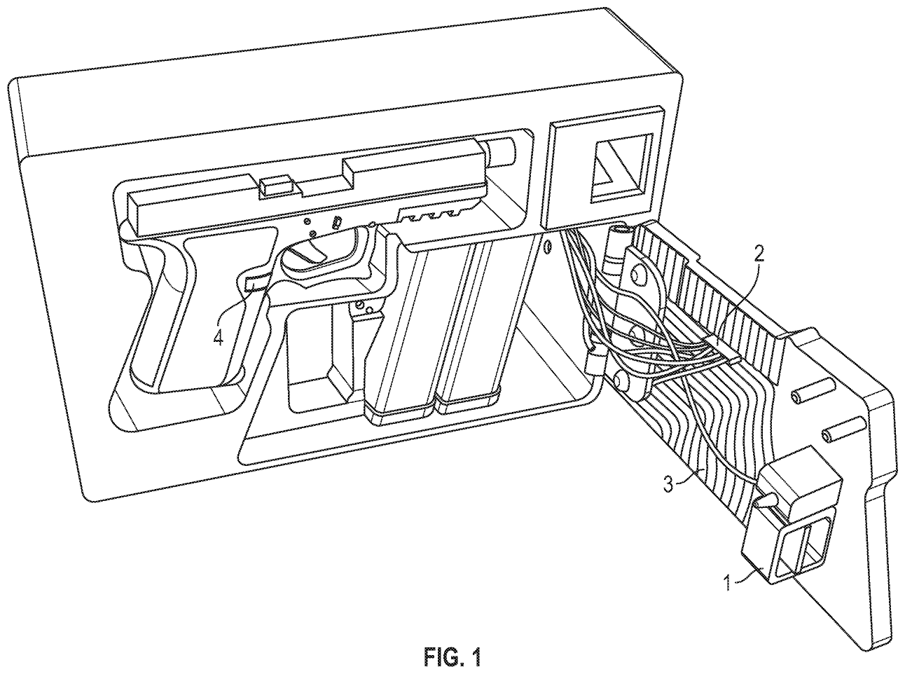

FIG. 2: front view of the instant invention in its open/unlocked position;

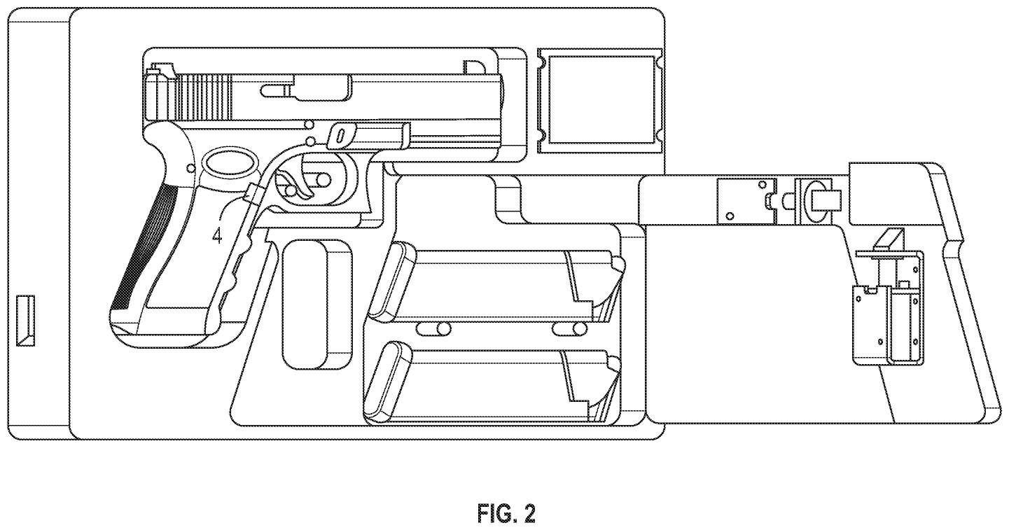

FIG. 3: external rendered view of the instant invention;

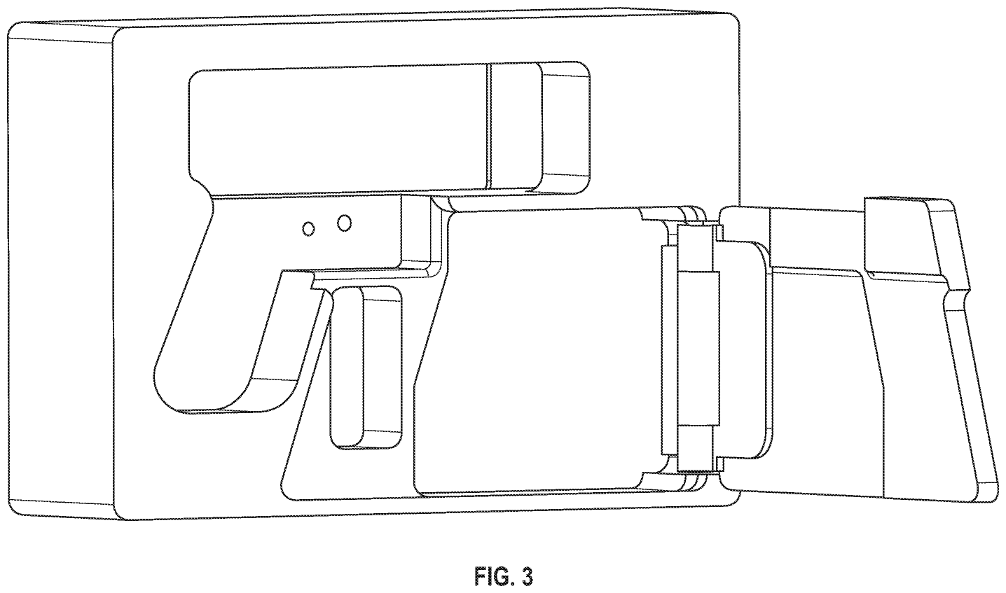

FIG. 4: internal rendered view of the instant invention;

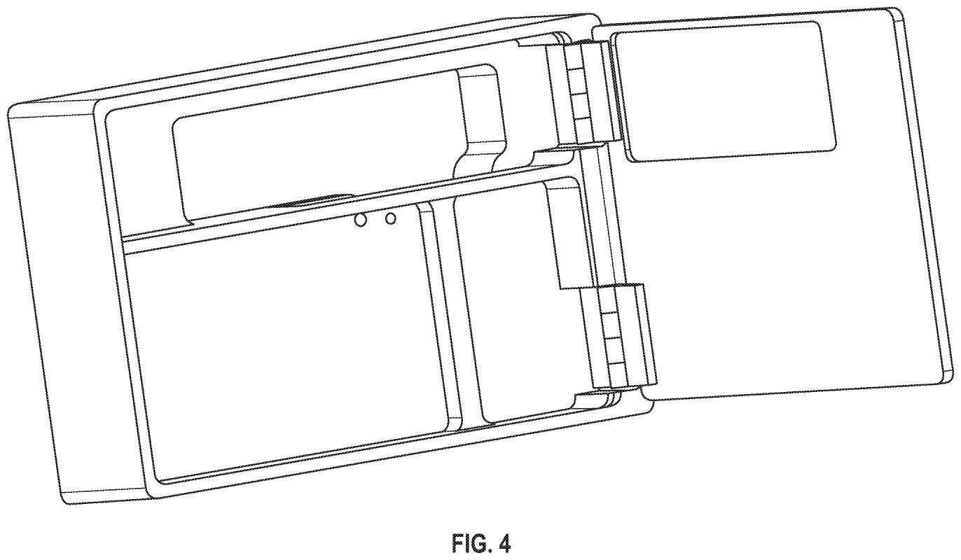

FIG. 5: exploded elevational view of the instant invention;

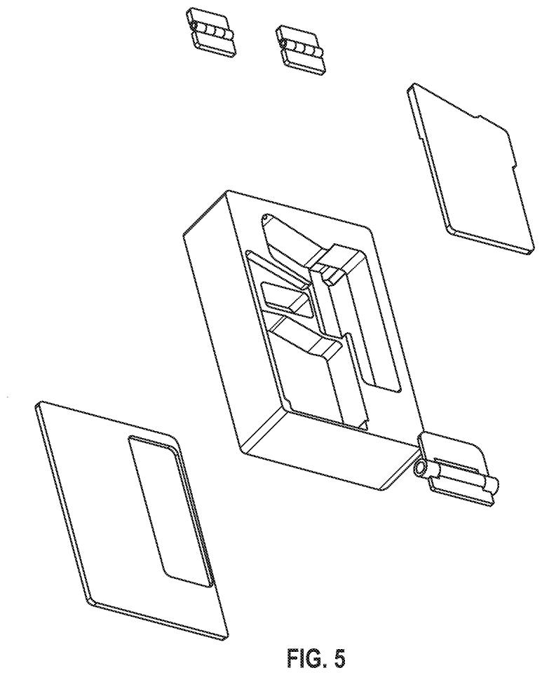

FIG. 6: perspective elevational view of the instant invention (alternative embodiment);

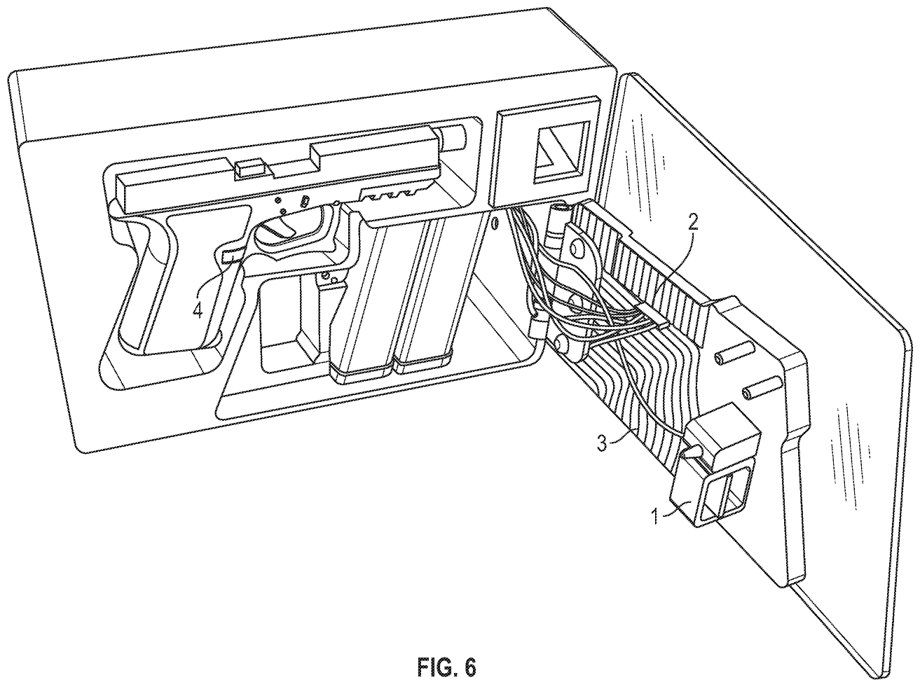

FIG. 7: front view of the instant invention (alternative embodiment);

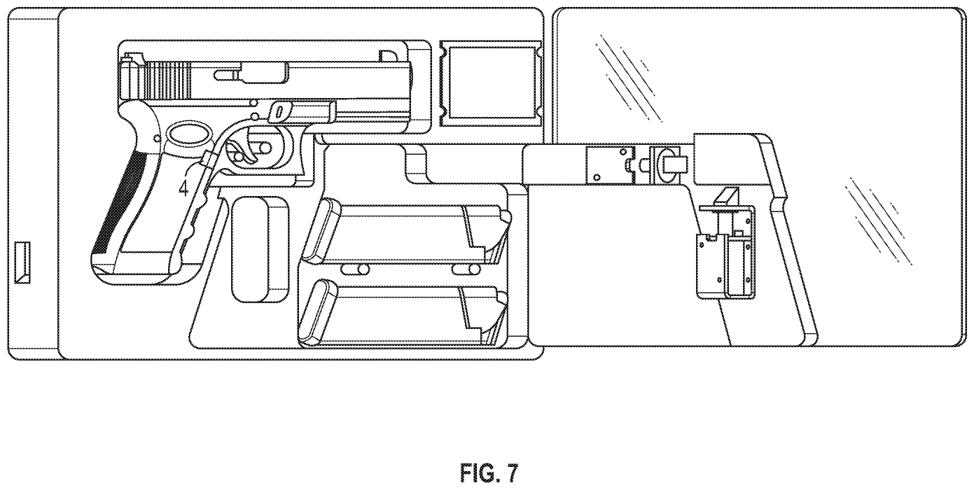

FIG. 8 rendered view of the instant invention (alternate embodiment);

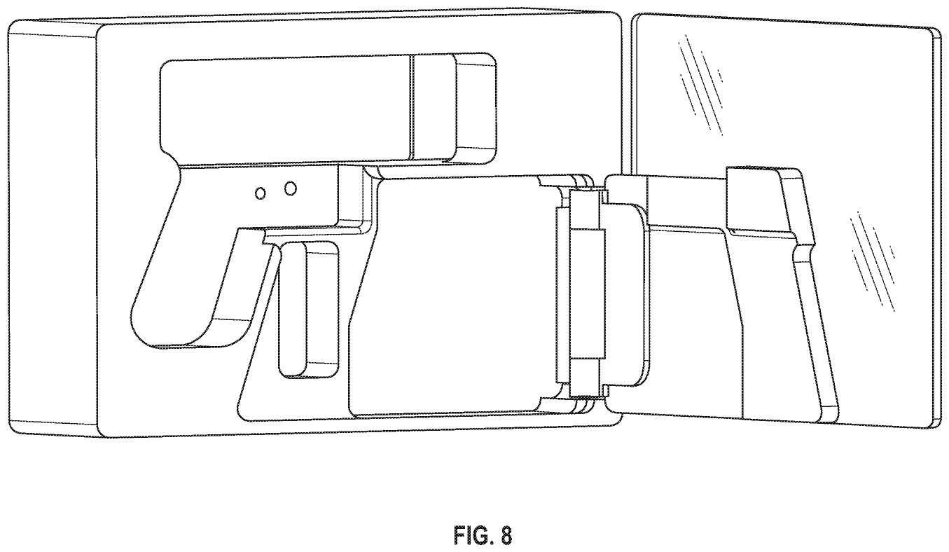

### DETAILED DESCRIPTION OF ILLUSTRATIVE EMBODIMENTS

### COMPONENTS LIST

001 Electromagnet (fits into coinciding magnetic enclosure in housing further comprising armature plate)
002 Power source (mobile power source)
003 Metallic enclosure for the electromagnets
004 Integrated Trigger Lock

### Relationship Between the Components

The power source (#2) allows the electromagnets to work (#1). They are protected by the metallic enclosure (#3). There is a trigger lock (#4) integrated into the enclosure.

### How the Invention Works

The electromagnet keeps the pistol locked to the enclosure with over 1000 lbs. of magnetic force. The shape of the enclosure and integrated trigger lock will prevent the pistol from being moved, slid, and the trigger and other mechanisms from being operated.

### How to Make the Invention

Construct the enclosure with integrated trigger lock, and insert the electromagnets. Solder the power source to the electromagnets. The power source can vary depending on the strength and type of electromagnet used.

All the elements are necessary for complete security. The power source can be hardwired stationary, or a mobile power source for temporary storage.

The power source and electromagnets can be reconfigured for varying levels of mobility and strength. The enclosure and trigger lock can also be reshaped for different types of firearms.

### How to Use the Invention

The person would first install the safe on a solid surface. They would then choose their lock configuration (bio fingerprint method, digital code, CNC code, mechanical NC code, Key Fob, RFID or any appropriate frequency mode, or appropriate unique lock configuration). Place the firearm on the enclosure, input the access method, and enjoy the security. To turn off the lock and renewable access, they would re-input the access method.

Additionally: The instant invention could be used to lock other metallic objects to surfaces that would otherwise be inconvenient or unreasonable to permanently lock.

Additionally: The instant invention may comprise a spring loaded solenoid, and may further comprise the following standard customary electronics specifications: the power for the electromagnet lock may be, inter alia, DC (Direct Current), appx. 5-6 W; the current is customarily around 0.5 A when the voltage supply is 12 VDC and customarily 0.25 A when using 24 VDC. These spec's increase geometrically for the electromagnetic force reaching 1000 lbs. Customarily, however, the specification of the electromagnet lock is dual voltage of 12/24 VDC.

Additionally, a glass-style transparent glass door/glass-case may cover the front of the device, thereby allowing an open style safe; it allows visibility of the gun stored at all times.

### Alternative Embodiments

The instant invention may also be embodied as:

a gun locking safe comprising: a gun; at least one active electromagnet of at least 1000 lbs. of electromagnetic force; a mobile power source; a metallic enclosure for said electromagnet;
a contoured gun housing comprising an integrated trigger lock;
a gun-safe-door connected to said housing via single hinge, said door therein juxtaposed with one side of the gun when the gun is positioned inside the contoured gun housing, such that the
door opens about the hinge, and wherein said housing further comprises
a recessed cavity for reception of a two-pinned trigger locking mechanism such that a uniquely-identified configured locking system, when identified and activated, deactivates said electromagnetic and therein allows access to said gun.

Or as:

The gun locking safe further comprising a solenoid actuator deadbolt integral shaft attached to the inside of said door for further safe closure and locking of the gun locking safe.

Or as:

The gun locking safe further comprising a transparent glass-style case-door affixed to the outer side of said safe-door, thereby allowing continued visibility of said gun without allowing physical upper-access to said gun unless-and-until said door is opened.

Or as:

The gun safe wherein said uniquely-identified configured locking system is a biometric fingerprint sensor identification system.

Or as:

The gun safe wherein said uniquely-identified configured locking system is a digital combination lock system.

Or as:

The gun safe wherein said uniquely-identified configured locking system is a CNC combination locking system.

Or as:

The gun safe wherein said uniquely-identified configured locking system is an RFID remote sensor system wherein said gun safe comprises the reader and the gun owner possesses the necessary RFID tag wherein the required frequency is detectable via the owner's physical proximity.

Or as:

The gun locking safe wherein the mobile power source is a USB port which allows for recharging.

Or as:

The gun locking safe wherein the mobile power source is a conventional power supply with associated optional four pin internal connector.

Or as:

A locking System for securing a firearm, said system comprising a first housing portion contoured to receive and secure said firearm; a second portion being a hinged door adapted to mate with said housing portion in order to securely enclose said firearm; wherein the locking means comprises at least one active electromagnet of at least 1000 lbs. of electromagnetic force; a mobile power source; a metallic enclosure for said electromagnet comprising an armature plate; and wherein said locking system further comprises an integrated trigger lock.

Or as:

The System wherein said locking means further comprises biometric fingerprint data.

Or as:

The System wherein said locking means further comprise a unique lock-configuration code.

Or as:

The System of wherein said locking means further comprises a solenoid deadbolt-style bar which slides to open position via an unlocking signal.

Or as:

The System wherein said locking means further comprises an actuator which opens by virtue of an electromagnetically-activated spring.

Or as:

The System wherein the housing portion, the door portion and the gun are together covered by a transparent glass-style case covering the outside of said door.

Or as:

The System wherein said electromagnet de-activates in response to a unique lock configuration, said configuration therein opening said integrated trigger lock.

Or as:

The System wherein the mobile power source is a USB port which allows for recharging.

Or as:

The gun locking safe wherein the mobile power source is a conventional power supply with associated optional four pin internal connector.

Or as:

The System wherein said electromagnetic locks said door when energized in a fashion collinear with the load such that the lock and the armature plate, when the housing and the door are mated, are positioned face-to-face to achieve the strongest possible attractive force, therein optimizing the locking force of the gun safe System.

Or as:

The System wherein an external transparent case allows visual confirmation of the System in its locked and unlocked position.

1. A gun locking safe comprising:
a gun;
at least one active electromagnet of at least 1000 lbs. of electromagnetic force;
a mobile power source;
a metallic enclosure for said electromagnet;
a contoured gun housing comprising an integrated trigger lock;
a gun-safe-door connected to said housing via single hinge, said door therein juxtaposed with one side of the gun when the gun is positioned inside the contoured gun housing, such that the
door opens about the hinge, and wherein said housing further comprises
a recessed cavity for reception of a two-pinned trigger locking mechanism such that a uniquely-identified configured locking system, when identified and activated, deactivates said electromagnetic and therein allows access to said gun.

2. The gun locking safe of claim 1, further comprising
a solenoid actuator deadbolt integral shaft attached to the inside of said door for further safe closure and locking of the gun locking safe.

3. The gun locking safe of claim 1, further comprising a transparent glass-style case-door affixed to the outer side of said safe-door, thereby allowing continued visibility of said gun without allowing physical upper-access to said gun unless-and-until said door is opened.

4. The gun safe of claim 1 wherein said uniquely-identified configured locking system is a biometric fingerprint sensor identification system.

5. The gun safe of claim 1 wherein said uniquely-identified configured locking system is a digital combination lock system.

6. The gun safe of claim 1 wherein said uniquely-identified configured locking system is a CNC combination locking system.

7. The gun safe of claim 1 wherein said uniquely-identified configured locking system is an RFID remote sensor system wherein said gun safe comprises the reader and the gun owner possesses the necessary RFID tag wherein the required frequency is detectable via the owner's physical proximity.

8. The gun locking safe of claim 1 wherein the mobile power source is a USB port which allows for recharging.

9. The gun locking safe of claim 1 wherein the mobile power source is a conventional power supply with associated optional four pin internal connector.

10. A locking System for securing a firearm, said system comprising a first housing portion contoured to receive and secure said firearm; a second portion being a hinged door adapted to mate with said housing portion in order to securely enclose said firearm;
wherein the locking means comprises at least one active electromagnet of at least 1000 lbs. of electromagnetic force;
a mobile power source;
a metallic enclosure for said electromagnet comprising an armature plate;
and wherein said locking system further comprises an integrated trigger lock.

11. The System of claim 10, wherein said locking means further comprises biometric fingerprint data.

12. The System of claim 10, wherein said locking means further comprise a unique lock-configuration code.

13. The System of claim 10, wherein said locking means further comprises a solenoid deadbolt-style bar which slides to open position via an unlocking signal.

14. The System of claim 10, wherein said locking means further comprises an actuator which opens by virtue of an electromagnetically-activated spring.

15. The System of claim 10 wherein the housing portion, the door portion and the gun are together covered by a transparent glass-style case covering the outside of said door.

16. The System of claim 10 wherein said electromagnet de-activates in response to a unique lock configuration, said configuration therein opening said integrated trigger lock.

17. The System of claim 10 wherein the mobile power source is a USB port which allows for recharging.

18. The gun locking safe of claim 1 wherein the mobile power source is a conventional power supply with associated optional four pin internal connector.

19. The System of claim 10 wherein said electromagnetic locks said door when energized in a fashion collinear with the load such that the lock and the armature plate, when the housing and the door are mated, are positioned face-to-face to achieve the strongest possible attractive force, therein optimizing the locking force of the gun safe System.

20. The System of claim 10 wherein an external transparent case allows visual confirmation of the System in its locked and unlocked positions.
